(19) United States
(12) Patent Application Publication
(10) Pub. No.: US 2018/0310629 A1
(43) Pub. Date: Nov. 1, 2018

(54) AIR ADJUSTING MECHANISM, ELECTRONIC CIGARETTE HAVING AIR ADJUSTING MECHANISM, AND AIR ADJUSTING METHOD

(71) Applicant: CHANGZHOU JWEI INTELLIGENT TECHNOLOGY CO., LTD., Changzhou (CN)

(72) Inventor: WEI-HUA QIU, ChangZhou (CN)

(21) Appl. No.: 16/029,660

(22) Filed: Jul. 9, 2018

Related U.S. Application Data
(63) Continuation-in-part of application No. PCT/CN2016/113554, filed on Dec. 30, 2016.

(30) Foreign Application Priority Data
Jan. 9, 2016 (CN) 201610013724.9

(51) Int. Cl. A24F 47/00; G05D 11/13

(52) U.S. Cl. CPC A24F 47/008; G05D 11/132

(57) ABSTRACT

An air adjusting mechanism for an electronic cigarette and method thereof provides an air adjusting assembly and a control system. The air adjusting assembly includes an air adjusting inner ring, an air adjusting outer ring, and a motor. The control system includes an input device or sensor, a storage, and a controller. Such electronic cigarette can automatically adjust the amount of air intake according to an expected working power or operating voltage or operating temperature of the atomizer as inputted by the user, or according to the value of a relative physical quantity x of smoke temperature or humidity detected by the sensor. Manual adjustment by user is not needed.

### FIELD

The present disclosure relates to electronic cigarette, and particularly to an air adjusting mechanism, an electronic cigarette having the air adjusting mechanism, and a method of the air adjusting.

### BACKGROUND

In general, an electronic cigarette is provided with an air adjusting mechanism, and a user can adjust the air inlet through the air adjusting mechanism to set the desired amount of airflow. A user, however, needs to manually adjust the electronic cigarette to control the amount of airflow, resulting in poor user experience. Therefore, it is necessary to provide an electronic cigarette that can automatically adjust the air intake.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a schematic view of an electronic cigarette, in accordance with a first embodiment of the present application.

FIG. 2 is a cross-sectional view of an atomizer with an air adjusting assembly of the cigarette shown in FIG. 1.

FIG. 3 is a block diagram of a control system connected with a motor and a battery assembly of the cigarette shown in FIG. 1.

FIG. 4 is a cross-sectional view along the direction A-A of the air adjusting assembly shown in FIG. 2 in which an air adjusting inner ring being positioned at a final position.

FIG. 5 is a cross-sectional view of the air adjusting assembly shown in FIG. 4, in which the air adjusting inner ring is positioned at a zero or final position.

FIG. 6 is a flowchart of an air adjusting method of the electronic cigarette shown in FIG. 1.

FIG. 7 is a schematic view of an electronic cigarette according to a second embodiment of the present disclosure.

FIG. 8 is a block diagram of a control system connected with a motor and a battery assembly of the cigarette shown in FIG. 7.

FIG. 9 is a flowchart of an air adjusting method of the electronic cigarette shown in FIG. 7.

### DETAILED DESCRIPTION

For a clearer understanding of the technical features, objectives, and effects of this disclosure, specific embodiments will be described with reference to the accompanying drawings. The described embodiments are a part but not all of the embodiments. All other embodiments possible by those of ordinary skill in the art without making creative efforts shall fall within the scope of protection of the present disclosure.

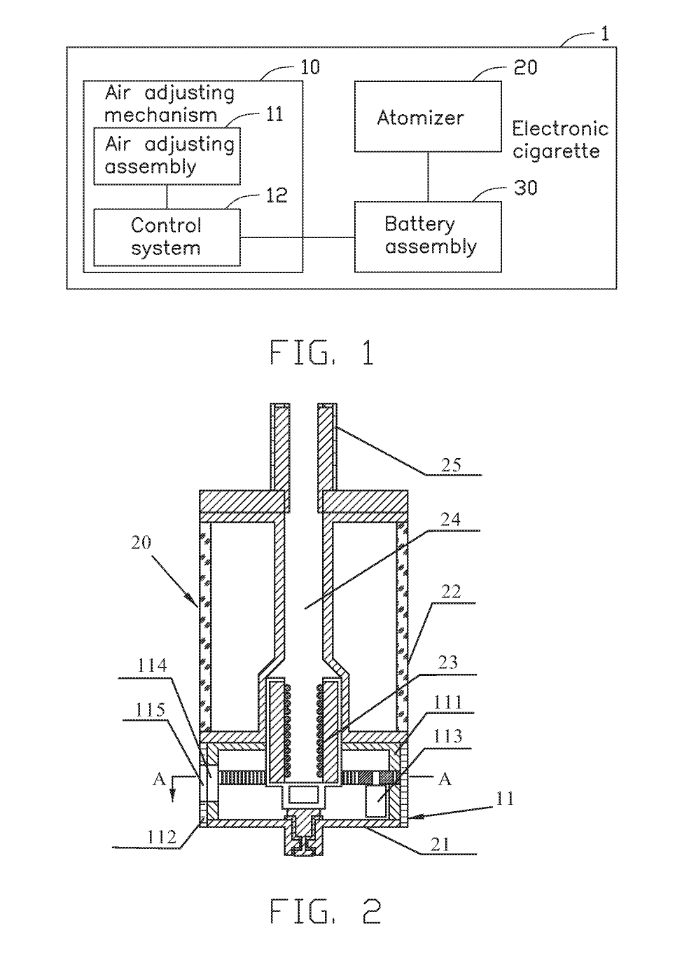

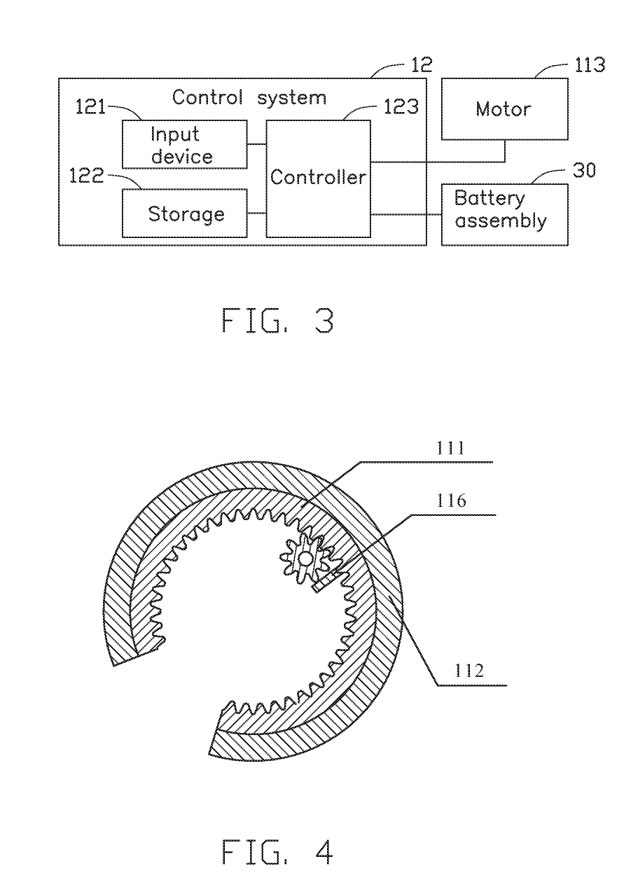

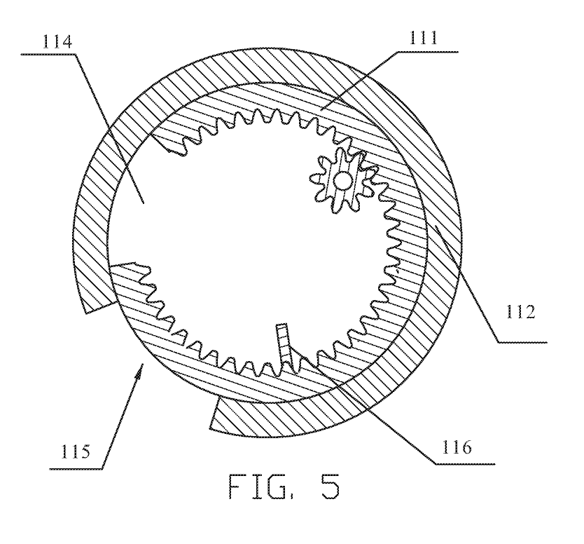

FIGS. 1-5 illustrate a first embodiment of an air adjusting mechanism 10. The air adjusting mechanism 10 includes an air adjusting assembly 11 and a control system 12. The air adjusting assembly 11 is positioned on the atomizer 20. In other embodiments, the air adjusting assembly 11 can be positioned on a battery assembly 30, or between the atomizer 20 and the battery assembly 30. The air adjusting assembly 11 includes an air adjusting inner ring 111, an air adjusting outer ring 112, and a motor 113. The air adjusting outer ring 112 is sleeved on the air adjusting inner ring 111. The air adjusting inner ring 111 defines a first air inlet 114. The air adjusting outer ring 112 defines a second air inlet 115. An end of the motor 113 is matched with the air adjusting inner ring 111 via gears. The motor 113 is capable of driving the air adjusting inner ring 111 when the motor 113 is rotated. In other embodiments, the end of the motor 113 can match with the air adjusting outer ring 112 via gears, and the motor 113 is capable of driving the air adjusting outer ring 112 when the motor 113 is rotated. Thereby, the first air inlet 114 and the second air inlet 115 can be aligned or staggered to adjust the amount of air intake. The control system 12 is positioned on the battery assembly 30. The control system 12 includes an input device 121, a storage 122, and a controller 123. The input device 121, the storage 122 and the motor 113 are both electrically connected to the controller 123. The controller 123 is also electrically connected to the battery assembly 30. The input device 121 is configured for a user to input a desired operating power or operating voltage or operating temperature of the atomizer 20. The storage 122 is configured to pre-store corresponding relationship data between an operating power or an operating voltage or an operating temperature of the atomizer 20 with a preset position of the air adjusting inner ring 111 or the air adjusting outer ring 112, and the corresponding relationship data between the preset position of the air adjusting inner ring 111 or the air adjusting outer ring 112 and a preset number of rotations of the motor 113. The controller 123 is configured to control the rotation of motor 113 to let the air adjusting inner ring 111 or the air adjusting outer ring 112 return to the initial position, and further configured to control the preset rotation number of motor 113 according to the pre-stored corresponding relationship data, so that the air adjusting inner ring 111 or the air adjusting outer ring 112 is rotated from the initial position to the preset position. Therefore the amount of air intake can be in accord with the operating power or operating voltage or operating temperature of the atomizer 20 inputted by the user.

In actual application, the pre-stored relationship data between the operating power or operating voltage or operating temperature of the atomizer 20 and the preset rotation number of the motor 113 can be a directly corresponding relationship data between the atomizer 20 and the motor 113, or be the corresponding relationship data between the operating power or operating voltage or operating temperature of the atomizer 20 with the preset position of the air adjusting inner ring 111, and the corresponding relationship data between the preset position of the air adjusting inner ring 111 and the preset number of rotations of the motor 113. When the pre-stored relationship data is the latter choice, the controller 123 can get the preset position of the air adjusting inner ring 111 according to the corresponding relationship data between the operating power or operating voltage or operating temperature of the atomizer 20 with the preset position of the air adjusting inner ring 111, and then the preset number of rotations of the motor 113 is ensured according to the corresponding relationship data between the preset position of the air adjusting inner ring 111 and the preset number of rotations of the motor 113, and the motor 113 is controlled to rotate.

The initial position can be a zero position or a final position. The zero position is the position of the air adjusting inner ring 111 or the air adjusting outer ring 112 when the amount of air intake is zero because the first air inlet 114 and the second air inlet 115 are completely offset. The final position is the position of the air adjusting inner ring 111 or the air adjusting outer ring 112 when the amount of air intake is at maximum and the first air inlet 114 and the second air inlet 115 are fully aligned.

In the first embodiment of the air adjusting mechanism 10, an end of the motor 113 matches the inner wall of the air adjusting inner ring 111 via gears.

Furthermore, a stopping member 116 is positioned on an inner wall of the air adjusting inner ring 111, and the stopping member 116 stops negative or further rotation of the air adjusting inner ring 111 in an initial position. The controller 123 can determine that the air adjusting inner ring 111 has been rotated to an initial position.

Furthermore, in the illustrated embodiment, the initial position is the final position. When the air adjusting inner ring 111 rotates anticlockwise to the final position, the stopping member 116 stops negative or further rotation of the air adjusting inner ring 111. Therefore, the controller 123 can determine that the air adjusting inner ring 111 has been rotated to the final position. When the air adjusting inner ring 111 rotates in reverse direction, the air adjusting inner ring can be rotated from the final position to a preset position.

Furthermore, the air adjusting assembly 11 is positioned on the atomizer 20. The atomizer 20 includes a base connecting member 21, a liquid storage assembly 22, and an atomizing head 23. An end of the air adjusting assembly 11 is connected to the base connecting member 21, and another end of the air adjusting assembly 11 is connected to the liquid storage assembly 22. The end of the base connecting member 21 opposite to the liquid storage assembly is connected to the battery assembly 30. The inner cavity of the liquid storage assembly 22 forms a smoke channel 24. An end of the atomizing head 23 is mounted in the inner cavity of the base connecting member 21, and the other end of the atomizing head 23 passes through the inner cavity of the air adjusting assembly 11 for insertion into the smoke channel 24. The end of the motor 113 away from the air adjusting inner ring 111 is mounted in the inner cavity of the base connecting member 21.

Furthermore, the atomizer 20 further includes a cigarette holder 25, the smoke channel 25 is mounted on the other end of the liquid storage assembly 22 opposite to the base connecting member 21. The smoke holder 25 communicates with the smoke passage 24. The smoke holder 25 is connected with the smoke channel 24.

The first embodiment of the present disclosure further provides an electronic cigarette 1. The electronic cigarette includes an atomizer 20 and a battery assembly 30, and further includes the air adjusting mechanism 10.

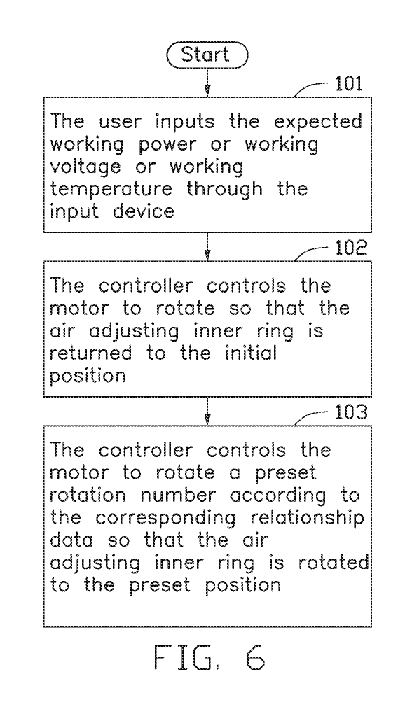

FIG. 6 illustrated an air adjusting method of the electronic cigarette 1 in the first embodiment. In the illustrated embodiment, the end of the motor 113 is matched with the air adjusting inner ring 111 via gears. The steps of the air adjusting method are as follows.

In step S101, the user inputs the expected operating power or operating voltage or operating temperature of the atomizer 20 via the input device 121, and then proceeds to step S102;

In step S102, the controller 123 controls the motor 113 to rotate so that the air adjusting inner ring 111 returns to the final position, and then proceeds to step S103;

In step S103, the controller 123 controls the motor 113 to rotate a preset rotation number according to the pre-stored relationship data between the pre-stored working power or operating voltage or operating temperature of the atomizer 20 and the preset number of rotations of the motor 113, so that the air adjusting inner ring 111 is rotated from the final position to the preset position. The pre-stored relationship data includes the corresponding relationship data between the operating power or operating voltage or operating temperature of the atomizer 20 with the preset position of the air adjusting inner ring 111, and the corresponding relationship data between the preset position of the air adjusting inner ring 111 and the preset number of rotations of the motor 113.

In other embodiments, the end of the motor 113 can be matched with the air adjusting outer ring 112 via gears, the steps of the air adjusting method of this condition can refer to the method described above.

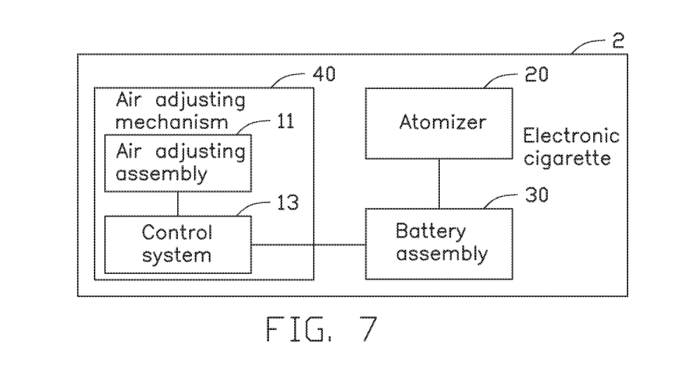

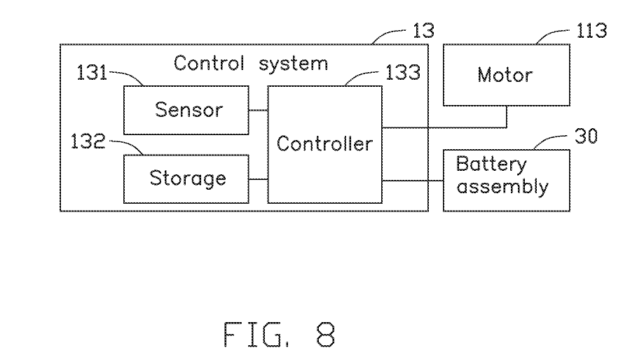

FIG. 7 and FIG. 8 illustrate a second embodiment of an air adjusting mechanism 40. The air adjusting mechanism 40 includes an air adjusting assembly 11 and a control system 13.

The control system 13 includes a sensor 131, a storage 132, and a controller 133. The input device 121 can include the sensor 131 as an automatic input device. The sensor 131 is positioned on the atomizer 20. The storage 132 and the controller 133 are positioned on the battery assembly 30. The sensor 131, the storage 132, and the motor 113 are electrically connected to the controller 133. The controller 133 is also electrically connected to the battery assembly 30. The sensor 131 is configured to detect the value of a relative physical quantity x which is related to the amount of air intake. The storage 132 is configured to pre-store corresponding relationship data between the value of the relative physical quantity x and the preset number of rotations of the motor 113. The controller 133 is configured to control the motor 113 to rotate so that the air adjusting inner ring 111 or the air adjusting outer ring 112 is returned to the initial position, and is further used to control the preset rotation of the motor 113 according to the pre-stored corresponding relationship data, so that the air adjusting inner ring 111 or air adjusting outer ring 112 is rotated from the initial position to a preset position. Thus the amount of air will satisfy the requirement of the value of the relative physical quantity x.

In the second embodiment, the pre-stored corresponding relationship data between the value of the relative physical quantity x and the preset number of rotations of the motor 113 may include a directly corresponding relationship date between the x and the motor 113, or include a corresponding relationship data between the value of the relative physical quantity x and preset positions of the air adjusting inner ring 111 or the air adjusting outer ring 112, and a corresponding relationship data between the preset position of the air adjusting inner ring 111 or the air adjusting outer ring 112 with the preset number of rotations of the motor 113. When the pre-stored corresponding relationship data between the value of the relative physical quantity x and the preset number of rotations of the motor 113 is the latter choice, the controller 133 determines the preset position of the air adjusting inner ring 111 or the air adjusting outer ring 112 according to the relative physical quantity x, and then determines the preset number of rotations of the motor 113 according to the preset position, and the motor 113 is controlled to rotate.

The relative physical quantity x is at least one of the temperature of the smoke, the humidity of the smoke, and the strength of vacuum applied to the cigarette holder 25 when the user inhales. When the temperature of the smoke is high or the smoke is dry or the vacuum pressure applied is high, it is necessary to increase the air intake amount. When the temperature of the smoke is low or the humidity of the smoke is wet or the vacuum pressure is small, it is necessary to reduce the air intake amount.

Accordingly, in order to detect the value of the relative physical x, the sensor 131 may include at least one of a temperature sensor, a humidity sensor, and a vacuum pressure sensor.

When the sensor 131 includes a temperature sensor, the temperature sensor can be positioned in the inner cavity of the cigarette holder 25, or positioned in the smoke channel 24, or positioned at inside the atomizing head 23, or positioned near the atomizing head 23.

When the sensor 131 includes a humidity sensor, the humidity sensor can be positioned in the inner cavity of the cigarette holder 25, or positioned in the smoke channel 24, or positioned at inside the atomizing head 23, or positioned near the atomizing head 23.

When the sensor 131 includes a vacuum pressure sensor, the sensor can be positioned close to the inner cavity wall of the cigarette holder 25, or positioned at inside the wall of the cigarette holder 25, or attached to the outer wall of the cigarette holder 25.

The storage 132 is further configured to store the value of the relative physical quantity x detected by the sensor 131.

The second embodiment of the present disclosure further provides an electronic cigarette 2. The electronic cigarette 2 includes an atomizer 20 and a battery assembly 30, and further includes the air adjusting mechanism 40.

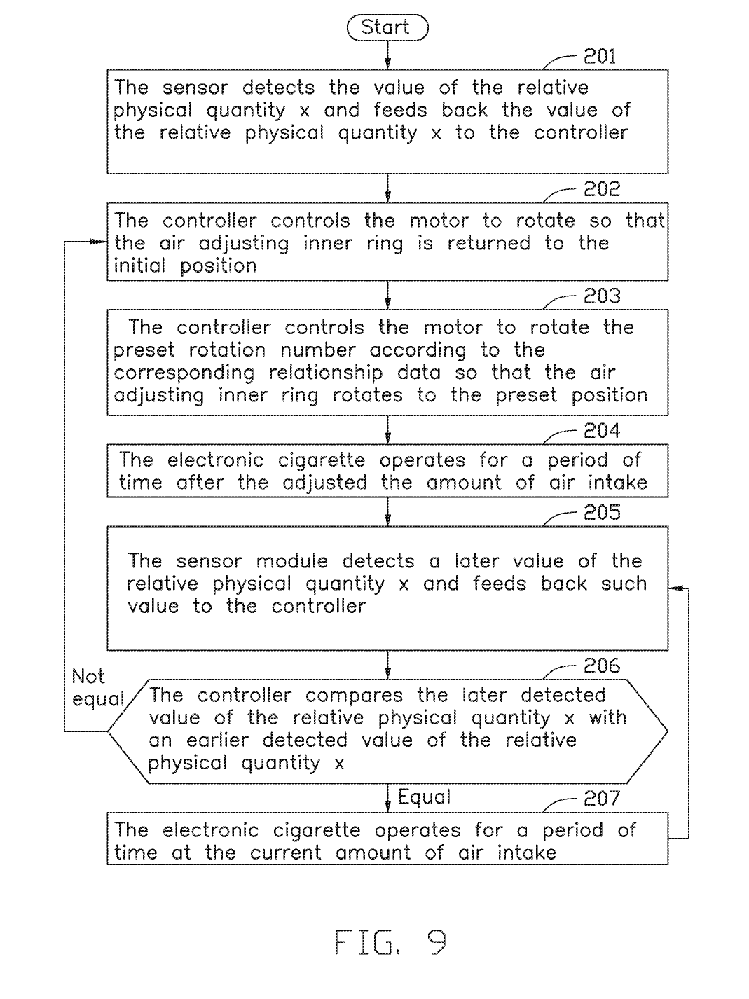

FIG. 9 illustrated an air adjusting method of the electronic cigarette 2 in the second embodiment. In the illustrated embodiment, the end of the motor 113 is matched with the air adjusting inner ring 111 via gears. The steps of the air adjusting method are as follows.

In step S201, the sensor 131 detects the value of the relative physical quantity x and feeds back the value of the relative physical quantity x to the controller 133. Then proceed to step S202.

In actual application, after the sensor 131 detected the value of the relative physical quantity x, the value of the relative physical quantity x is stored in the storage 132. Alternatively, the sensor 131 feeds back the value of the relative physical quantity x to the controller 133, and the controller 133 control the value of the relative physical quantity x to be stored in the storage 132.

In step S202, the controller 133 controls the motor 113 to rotate so that the air adjusting inner ring 111 returns to the initial position, and then proceed to step S203.

In step S203, the controller 133 controls the preset rotation of the motor 113 according to the corresponding relationship data between the pre-stored value of the correlation physical quantity x and the preset number of rotations of the motor 113, so that the air adjusting inner ring 111 is rotated from the initial position to the preset position. Then proceed to step S204. The corresponding relationship data is already described in the second embodiment, there is no need to repeat.

In step S204, the electronic cigarette 2 operates for a period of time after adjusting the amount of air intake, and then proceed to step S205.

In step S205, the sensor 131 detects a later value of the relative physical quantity x and feeds back such value to the controller 133. Then, the process proceeds to step S206.

In actual application, after the sensor 131 redetected the value of the relative physical quantity x, the process proceeds to step S206.

In step S206, the controller 133 compares the later detected value of the relative physical quantity x with an earlier detected value of the relative physical quantity x. If they are equal, the process proceeds to step S207, if not, the process proceeds to step S202.

Alternatively, after the sensor 131 detected the value of the relative physical quantity x, the value of relative physical quantity x is stored in the storage 132. When the sensor redetects the value of relative physical quantity x, the controller 133 compares the later detected value of the relative physical quantity x with the earlier stored value of the relative physical quantity x. If they are equal, the process proceeds to step S207, if not, the process proceeds to step S202.

In step S207, the electronic cigarette 2 operates for a period of time at the current amount of air intake, and then proceeds to step S205.

In other embodiments, the end of the motor 113 can be matched with the air adjusting outer ring 112 via gears, the details of air adjusting method of this condition can refer to the method described above.

The present disclosure enables automatic adjustment of the amount of air intake based on the desired operating power or operating voltage or operating temperature of the atomizer 20 inputted by the user, or based on the value of the relative physical quantity x detected by the sensor 131. The user does not need to manually adjust, thereby making the electronic cigarette more suited to him or her, improving the user experience.

The embodiments shown and described above are only examples. Many details are often found in the relevant art, therefore many such details are neither shown nor described. Even though numerous characteristics and advantages of the embodiments have been set forth in the foregoing description, together with details of the structure and function of the embodiments, the present disclosure is illustrative only, and arrangement of parts within the principles of the embodiments to the full extent indicated by the broad general meaning of the terms in which the appended claims are expressed.

What is claimed is:

1. An air adjusting mechanism, the air adjusting mechanism is configured for an electronic cigarette, the electronic cigarette comprises an atomizer and a battery assembly, the air adjusting mechanism comprises an air adjusting assembly, the air adjusting assembly comprises:
an air adjusting inner ring;
an air adjusting outer ring; and
a motor,
wherein the air adjusting outer ring is sleeved on the air adjusting inner ring, and the air adjusting inner ring defines a first air inlet, and the air adjusting outer ring defines a second air inlet, and an end of the motor is matched with the air adjusting inner ring or the air adjusting outer ring via gears, the motor is capable of driving the air adjusting inner ring or the air adjusting outer ring when the motor is rotated, so that the first air inlet and the second air inlet are aligned or staggered.

2. The air adjusting mechanism as claimed in claim 1, wherein the air adjusting mechanism comprises a control system, the control system comprises:
an input device, configured for the user to input the expected working power or working voltage or working temperature of the atomizer,
a storage, configured to pre-store the relationship between the operating power or operating voltage or operating temperature of the atomizer and a preset rotation number of the motor, and
a controller, configured to control the motor to rotate so that the air adjusting inner ring or air adjusting outer ring is returned to an initial position, also configured to control the preset number of rotations of the motor according to the pre-stored corresponding relationship data, thus the air adjusting inner ring or the air adjusting outer ring is rotated from the initial position to the preset position.

3. The air adjusting mechanism as claimed in claim 2, wherein the air adjusting assembly is positioned on the atomizer, or on the battery assembly, or between the atomizer and the battery assembly, and the control system is positioned on the battery assembly.

4. The air adjusting mechanism as claimed in claim 2, wherein the initial position is a zero position or a final position.

5. The air adjusting mechanism as claimed in claim 1, wherein an end of the motor is matched with the inner wall of the air adjusting inner ring via gears.

6. The air adjusting mechanism as claimed in claim 5, wherein a stopping member is positioned on the inner wall of an air adjusting inner ring, and the stopping member stops negative or further rotation of the air adjusting inner ring when the air adjusting inner ring is at the initial position.

7. The air adjusting mechanism as claimed in claim 1, wherein the air adjusting assembly is positioned on an atomizer, and the atomizer comprises a base connecting member, a liquid storage assembly, and an atomizing head, an end of the air adjusting assembly is connected with the base connecting member, the other end of the air adjusting assembly is connected with the liquid storage assembly, the end of the base connecting member opposite to the liquid storage assembly is connected to the battery assembly, the inner cavity of the liquid storage assembly forms a smoke channel, an end of the atomizing head is mounted in the inner cavity of the base connecting member, and the other end of the atomizing head passes through the inner cavity of the air adjusting assembly and is inserted into the smoke channel, the end of the motor away from the air adjusting inner ring is mounted in the inner cavity of the base connecting member.

8. The air adjusting mechanism as claimed in claim 2, wherein the input device comprises a sensor,
the sensor is configured to detect the value of the relative physical quantity x related to the air intake amount,
the storage is configured to pre-store relationship between the value of the relative physical quantity x a preset rotation number of the motor.

9. The air adjusting mechanism as claimed in claim 8, wherein the air adjusting assembly is positioned on the atomizer, or positioned on the battery assembly, or positioned between the atomizer and the battery assembly, and the sensor is positioned on the atomizer, the storage and the controller are positioned on the battery assembly.

10. The air adjusting mechanism as claimed in claim 8, wherein the relative physical quantity x can represent at least one of a temperature of the smoke, a humidity of the smoke, and a strength of vacuum applied to the cigarette holder when the user inhales.

11. The air adjusting mechanism as claimed in claim 10, wherein the sensor comprises at least one of a temperature sensor, a humidity sensor, and a pressure sensor.

12. The air adjusting mechanism as claimed in claim 11, wherein when the sensor comprises a temperature sensor or a humidity sensor, the temperature sensor or the humidity sensor is positioned in the inner cavity of the cigarette holder, or positioned in the smoke channel, or positioned at the inside of the atomizing head, or positioned near the atomizing head.

13. The air adjusting mechanism as claimed in claim 11, wherein when the sensor comprises a pressure or vacuum sensor, the pressure sensor is positioned close to the inner cavity wall of the cigarette holder, or positioned in the wall of the cigarette holder, or positioned close to the outer wall of the cigarette holder.

14. An air adjusting method of an electronic cigarette, the electronic cigarette comprises an air adjusting mechanism and an atomizer; the air adjusting mechanism comprises an air adjusting assembly and a control system; the air adjusting assembly comprises an air adjusting inner ring, an air adjusting outer ring, and a motor; the control system comprises an input device, a storage, and a controller; wherein the air adjusting method comprises the steps of:
the input device receives the expected atomizer operating power or operating voltage or operating temperature inputted by the user;
the controller controls the rotation of the motor to return the air adjusting inner ring or the air adjusting outer ring to the initial position; and
the controller controls the motor according to a relationship between the working power or operating voltage or operating temperature of the atomizer and the preset number of rotations of the motor to adjust the air adjusting inner ring or the air adjusting outer ring from the initial position to a preset position.

15. The air adjusting method as claimed in claim 14, wherein the input device comprises a sensor, the step of the input device receiving the expected atomizer operating power or operating voltage or operating temperature is replaced by:
the sensor detects the value of a relative physical quantity x, and feeds back the value of the relative physical quantity x to the controller; and
the step of the controller controlling the motor according to the relationship between the working power or operating voltage or operating temperature of the atomizer and the preset number of rotations of the motor to adjust the air adjusting inner ring or the air adjusting outer ring from the initial position to a preset position is replaced by:
the controller controls the motor according to a relationship between the relative physical quantity x and the preset number of rotations of the motor to adjust the air adjusting inner ring or the air adjusting outer ring from the initial position to a preset position.

16. The air adjusting method as claimed in claim 15, wherein after the step of the controller controlling the motor according to a relationship between the relative physical quantity x and the preset number of rotations of the motor to adjust the air adjusting inner ring or the air adjusting outer ring from the initial position to a preset position, the method comprises a step of:
the electronic cigarette operates for a period of time after adjustment of the amount of air intake.

17. The air adjusting method as claimed in claim 16, wherein the step of the air adjusting method that electronic cigarette operating for a period of time under the adjusted amount of air intake further comprises:
the sensor detects the value of the relative physical quantity x again, and feeds back such value to the controller;
the controller compares the detected value of the relative physical quantity x with a previous value, and determines whether they are the same;
the controller controls the electronic cigarette to work for a period of time under the current amount of air intake or an adjusted amount of air intake according to the result of comparison.

18. The air adjusting method as claimed in claim 17, wherein the step of the air adjusting method that controller controlling the electronic cigarette to operate for a period of time under the current amount of air intake or the adjusted amount of air intake according to the comparison and determination further comprises:
when the later value of the relative physical quantity x detected again is equal to a previous detected value, the electronic cigarette is operated for a period of time under the current amount of air intake;
when the later value of the relative physical quantity x is not the same as the previous detected value, the controller controls the motor to rotate so that the air adjusting inner ring or air adjusting outer ring is returned to the initial position, the controller controls the motor according to the relationship between the pre-stored value of the relative physical quantity x and the preset number of rotations of motor, so that the air adjusting inner ring or the air adjusting outer ring is rotated from the initial position to the preset position, the electronic cigarette operates for a period of time after the adjustment of the amount of air intake.

19. An electronic cigarette, comprising an atomizer, a battery assembly, and an air adjusting mechanism, wherein the air adjusting mechanism comprises an air adjusting assembly, the air adjusting assembly comprises an air adjusting inner ring, an air adjusting outer ring, and a motor; the air adjusting outer ring is sleeved on the air adjusting inner ring, and the air adjusting inner ring defines a first air inlet, and the air adjusting outer ring defines a second air inlet, and an end of the motor is matched with the air adjusting inner ring or the air adjusting outer ring via gears, the motor is capable of driving the air adjusting inner ring or the air adjusting outer ring when the motor is rotated, so that the first air inlet and the second air inlet are aligned or staggered.
